(19) United States
(12) Patent Application Publication
(10) Pub. No.: US 2012/0072251 A1
(43) Pub. Date: Mar. 22, 2012

(54) Method, management procedure, process, an instrument and apparatus for delay estimation and mitigation of delay risks in projects and program

(76) Inventors: Cristian Mircean, Munchen (DE); Oliver Mâckel, Heimstetten (DE)

(21) Appl. No.: 12/885,774

(22) Filed: Sep. 20, 2010

(51) Int. Cl. G06Q 10/00

(52) U.S. Cl. 705/7.11

(57) ABSTRACT

In a method of delay estimation and a project management tool with at least a delay estimation module, the delay estimation module and the method of delay estimation estimating delays at least by dividing a work breakdown structure of a project plan in a plurality of elements, identifying a plurality of risks and uncertainties in connection with the plurality of elements provided in the work breakdown structure, estimating a plurality of best duration uncertainty distributions for each element of the plurality of elements, synthesizing, using the plurality of best duration uncertainty distributions, a work breakdown structure of a project plan with uncertainties, and creating an estimate of delays for the project plan.

### TECHNICAL FIELD

The present invention relates generally to methods for time management in projects and programs, to delay estimation, but and, not exclusively, it relates to a method of delay estimation.

The present invention also relates to a structured methodology that focuses on minimizing and mitigating project specific risks.

The present invention further relates to the set of procedures, processes, instruments or apparatus aimed at estimating milestones or delays with the presented methodology.

### BACKGROUND

Large-scale projects have contractual conditions that stipulate how to deal with corresponding penalties of delays, should the delays occur. Following the old cliché “time is money”—present day projects' risk analysis typically covers the delays by evaluating and understanding the contractual conditions, and later considering the impact resulting from these delays as liquidated damages. The compensation that the parties will receive upon a breach of contract, such as a delay or late performance, is generally detailed in the contract.

Based on an utility function, milestones during project and/or the end of projects may be categorized in what are called soft-deadline and hard-deadline. Should each of said soft-deadline and hard-line milestone/projects be represented via the utility function vs. milestone time variability (delay), in contrast with the soft-end projects, the hard-end projects posses a decrease of utility function with a vertical asymptote character around the deadline for project completion.

In extreme situations, the utility function itself may fall under zero (projects may generate losses to both constructor and customer). In upper described cases, in order to estimate hard-deadline milestones and/or end of projects or programme is critical to employ time dimension.

Existing risk analysis methodologies focus on estimating the impact of the project delays from the cost perspective. Although efficient when applied to soft-end projects, the existing methodologies are biased in the case of hard-end projects.

When characterized via an utility function, projects that have hard deadlines, the value of the utility function falls towards zero and may drop dramatically reaching zero values. Specific is the slope ∂_{utility}/∂ₜᵢₘₑ=−∝ with an obvious negative trend. An example of a project with a hard-deadline would be to build a stadium for the “future Olympics Games”. If the project is achieved weeks after the “Olympics Games” start, the utility function of such a project drops to negative values represented by the loss of investment costs and loss for the customers.

Existing risk analysis methodologies observe risks from monetary terms perspective. The typical risks are correlated with an increase in final project costs. As discussed above, around hard deadlines the cardinal utility function has a dramatic drop. In other words the aim of the project may decrease or even disappear. These are typically crisis situations, when the respective project is in an unstable and dangerous economic situation. Project crisis are specific, unexpected, and non-routine events or series of events that create high levels of uncertainty and threat or perceived threat to a project's high priority goal.

Handling of crisis is not the subject of the current invention, the methods and apparatuses of the present invention helping to prevent such crisis events. As discussed above, currently employed risk analysis methodologies observe risks in monetary terms, and managers are poorly equipped to quantify the impact of risks in terms of time for hard-deadline projects. Handling of time-risks for hard-deadline projects shall be distinct from handling cost-related risks.

### SUMMARY

Therefore, according to various embodiments a new risk analysis tool and methodology can be provided that supports the characterization of risks in time delay terms, and supports decision making regarding estimating delays, project risks, resource allocation, or any other project specific success estimates.

According to an embodiment, a method of delay estimation may comprise at least the steps of identifying based on a work breakdown structure (WBS) of a programme/project plan or interviews a plurality of elements called risk-breakdown structure (RBS); identifying a plurality of risks and uncertainties in connection with the plurality of elements comprised in the risk breakdown structure (RBS); estimating a plurality of best duration uncertainty distributions for each element of the plurality of work breakdown structure (WBS) elements; synthesizing using the plurality of duration distributions and identified plurality of risks in connection with the plurality of elements comprised in the risk breakdown structure (RBS) a novel work breakdown structure of a project plan with risk; and creating an estimate for delays for the plan or milestones in the plan.

### BRIEF DESCRIPTION OF THE DRAWINGS

The present invention together with the above and other objects and advantages may best be understood from the following detailed description of various embodiments illustrated in the drawings.

FIG. 1 is a schematic representation of the method of delay estimation and involved processes according to an embodiment;

FIG. 2 is a representation of four histograms representing distributions of the end-of-the-activity curves;

FIG. 3 is a representation of Gantt schematics;

FIG. 4 is a representation of the table used to acquire the variability of activities, activities are listed based on work breakdown structure for an example project;

FIG. 5 illustrates an example table used to acquire the event risks as acquired by the moderator;

FIG. 6 represents an example of event risk portfolio before and after successful mitigation;

FIG. 7 represents four types of results, according to various embodiments;

### DETAILED DESCRIPTION

Non-limiting and non-exhaustive embodiments are described with reference to the above referenced figures, wherein like reference numerals refer to like parts throughout the various views unless otherwise specified. The order of description should not be construed as to imply that these operations are necessarily order-dependent.

According to further embodiments, the procedures, processes, and the apparatus can be provided and may comprise at least the steps of identifying based on a work breakdown structure (WBS) of a programme/project plan or interviews a plurality of elements called risk-breakdown structure (RBS); identifying a plurality of risks and uncertainties in connection with said plurality of elements comprised in the risk breakdown structure (RBS); estimating a plurality of best duration uncertainty distributions for each element of said plurality of work breakdown structure (WBS) elements; synthesizing using the plurality of duration distributions and identified plurality of risks in connection with said plurality of elements comprised in the risk breakdown structure (RBS) a novel work breakdown structure of a project plan with risk; and creating an estimate for delays for the said plan or milestones in the said plan.

According to further embodiments, the visualization of the event-risk delays can be provided as round circles on two-dimensional orthogonal representation. Each event-risk delay is represented on the horizontal axis based on the estimated delay introduced by the respective event-risk delay at the evaluated milestone and on the vertical axis by the probability of the event-risk delay obtained from specialists. The diameter of the circular representation is the subjective feeling of the team.

The method of delay estimation along with the procedures, processes, instrument or apparatus according to various embodiments can be flexible so that they may be tailored to the specific phase of a project ranging from acquisition to the project acceptance phase. The method according to various embodiments and its corresponding procedures, processes, instrument or apparatus may lend themselves to a workshop-based risk management approach that ensures common understanding of the project's inherent opportunities, risks and uncertainties—due to the moderation, facilitation, and involvement of key personnel from different disciplines of the project.

The method of delay estimation along with the procedures, processes, instrument or apparatus according to various embodiments may provide support to managers at diverse levels to better manage the programme and/or projects in general, evaluate the criticality of delays and perform time management for respective programme and projects in special. The method of delay estimation along with the procedures, processes, instrument or apparatus according to various embodiments may provide support to managers for specific success estimates. Intended as a tool—the method and the procedures, processes, instrument or apparatus according to various embodiments have no intent to replace or reduce the expertise or the act of the manager.

The method of delay estimation according to various embodiments may further comprises the step of defining a set of goals for a delay analysis based on a stakeholder analysis and on project goals.

Subsequently, the method of delay estimation according to various embodiments may comprise the step of setting up a project specific risk breakdown structure based on the work breakdown structure of a project plan.

Then, the method of delay estimation according to various embodiments may comprise the step of gaining an understanding regarding the event-risks and opportunities based on planed activities in said project plan and variability of activities from said project plan, followed by making an evaluation of the plurality of uncertainties.

The variability of activities according to various embodiments may comprise making a quantitative and a qualitative variability analysis based at least on one of a probability that the respective activity generated delay, an estimated most likely duration, a qualitative team feeling on the activity, a minimum activity duration in optimistic situation, a maximum duration in a pessimistic situation, and a confidence with the most likely activity duration. These last 4 characteristics are employed to generate an uncertainty distribution of the end of the activities.

The event-risks analysis according to various embodiments may comprise making a quantitative and qualitative analysis based at least on one of a probability of each event-risk, qualitative team feeling on the respective risk, minimum duration the event-risk may introduce, most-likely duration the risk will introduce, maximum duration the event-risk may introduce in worst scenario, and confidence with the most likely duration. The last 4 characteristics of event-risks may depreciate (overwrite) the characteristics of the activity itself. Each event-risk may influence one or several activities in said project plan. The event-risks analysis according to various embodiments may comprise a recording step of the activities that are influenced by the up-enumerated event-risks (otherwise the entire set of activities in said project is assumed).

The opportunity analysis according to various embodiments may comprise making a quantitative and qualitative analysis based at least on one of a probability of each opportunity, qualitative team feeling on achieving respective opportunity, minimum duration saved by opportunity, most-likely duration the opportunity reduce, maximum duration the opportunity may reduce in best scenario, and confidence with the most likely duration. The last 4 characteristics of opportunity may overwrite the characteristics of the activity itself. Each opportunity may influence one or several activities in said project plan. The opportunity analysis according to various embodiments may comprise a recording step of activities that are influenced by the up-enumerated opportunities.

Afterward, an event correlation analysis is performed. If event-risks are independent the probability of occurrence is the product of the probabilities. The impact (e.g., in days) of the correlated event is to be assessed individually for each event-risk combination independently.

Risk awareness check is constructed from plotting the acquired qualitative values vs. quantitative risks. Quantitative risk values are the product of risk' probability (usually measured in percentage) and risk' impact (usually estimated in days). Qualitative values assigned to risks are subjective ranking of risks (e.g., from 1 to 10) by the team, prior to a quantitative assessment.

The method of delay estimation according to various embodiments further may comprise visualizing techniques, at least one of visualizations of the event-risk's probability vs. impact for the risk portfolio; visualization of qualitative risk values vs. quantitative risks; visualization of opportunities' probability vs. impact.

The method of delay estimation according to various embodiments further yet may comprise mitigating risk—here as variability of activities, event risks and correlated risks—based on said estimate of delays for said project plan.

For each mitigation option of event-risks, the method of delay estimation according to various embodiments further yet may comprise on making a quantitative and qualitative analysis of the mitigation impact based at least on one of a probability event-risk decreases, minimum duration the event-risk may introduce when the mitigation is successful, most-likely duration the risk will introduce with mitigation in place and when the mitigation is successful, maximum duration the event-risk may introduce in worst scenario with mitigation in place and when the mitigation is successful, and confidence with the most likely duration.

The method of delay estimation according to various embodiments further yet may comprise at least estimating the end-of-project and its duration distribution. The method of delay estimation according to various embodiments may further comprise estimating one or several milestones with importance for said project, evaluating a schedule sensitivity index (SSI) for the entire project or for one or several milestones. The method of delay estimation according to various embodiments may further comprise an analysis of a critical path and prioritization of risks follows the step of evaluating a schedule sensitivity index (SSI), and further comprises planning measures for risk mitigation.

The method of delay estimation according to various embodiments may further comprise calculating and illustrating an achievable mitigation for each mitigation measure, demonstrating an overall achievable risk reduction, and controlling mitigation measures in accordance to a risk mitigation implementation procedure.

The method according to various embodiments may combine moderation techniques with the aim of revealing the intrinsic technical risk of the projects. In addition to the technical risks, the methodology brigs evidence of “soft” risks such as related to the teams efficiency, and un-correlations or miss-understandings regarding the role of team members in the team. A professional moderator has to be employed, so that he encourages the common understanding of risks for participants, helping to crystallize the essence of what can go wrong in complex situations and where the opportunities can be unlocked. The moderator shall discuss the project in a structured manner, following a risk break down structure that may be derived from the work breakdown structure. The method according to various embodiments may promote a structured qualitative and quantitative risk assessment while allowing a transparent presentation of risk facilitates quantifying the potential impact on the finalization of the project in days and the probability in percentages.

### Terminology Employed

In the context of the describing the embodiments, the following terminology will be employed, in non-restrictive sense.

Project Management definitions are the typical understanding within Project Management Institute collected and organized for their members in “A Guide to the Project Management Body of Knowledge (PMBOK® Guide)”. One of aims of Project Management Institute is to create a common standard for project managers. Unless otherwise specified the terms are associated the meaning described below.

Work Breakdown Structure (WBS) is a deliverable-oriented hierarchical decomposition of the work to be executed by the project team to accomplish the project objectives and create the required deliverables. It organizes and defines the total scope of the project. In the context of various embodiments the terms “work break down structure” have also associated the meaning of the tool used to define and group a project's discrete work elements or tasks in a way that helps organize and define the total work scope of the project.

A work breakdown structure element may be a product, data, a service, or any combination. A WBS also provides the necessary framework for detailed cost estimating and control along with providing guidance for schedule development and control. Additionally the WBS is a dynamic tool and can be revised and updated as needed by the project manager.

In the context various embodiments the term “project plan” is associated the meaning of a formal, approved document used to guide both project execution and project control. The primary uses of the project plan are to document planning assumptions and decisions, facilitate communication among stakeholders, and document approved scope, cost, and schedule baselines. A project plan may be summarized or detailed. At a minimum, a project plan is expected to answer basic questions about the project such as what is the problem or value proposition addressed by the project, why is it being sponsored, what is the work that will be performed on the project, what are the major products/deliverables, who will be involved and what will be their responsibilities within the project, how will they be organized, what is the project timeline and when will particularly meaningful points, referred to as milestones, be complete, etc.

In the context of various embodiments the term “Risk” is associated the meaning of an uncertain event or condition that, if it occurs, has a negative effect on a project's objectives.

In the context of various embodiments the term “Uncertainty” is the lack of certainty, a state of having limited knowledge where it is impossible to exactly describe existing state or future outcome, more than one possible outcome.

In the context of various embodiments the term “Opportunity” is associated the meaning of an uncertain event or condition that, if it occurs, has a positive effect on a project's objectives.

In the context of various embodiments the term “duration distribution” is associated the meaning of distribution in probability theory and statistics. The end of the project yields a probability distribution of the value falling within a particular interval, duration is a continuous variable. The probability distribution of duration describes the range of possible values that random variable duration can attain and the probability that the value of the random variable is within any measurable subset of that range.

In the context of various embodiments the term “estimate of delays” is associated the meaning of approximation. An approximation is an inexact representation of something that is still close enough to be useful. Approximations are used because incomplete information prevents use of exact representations. The delay problem is too complex to solve analytically. Thus, even when the exact representation is known, an approximation may yield a sufficiently accurate solution while reducing the complexity of the problem significantly.

In the context of various embodiments the term “stakeholder” is associated the meaning of person or organization (e.g., customer, sponsor, performing organization, or the public) that is actively involved in the project, or whose interests may be positively or negatively affected by execution or completion of the project. A stakeholder may also exert influence over the project and its deliverables.

In the context of various embodiments the term “stakeholder analysis” is associated the meaning of a process of identifying all people or organizations impacted by the project, and documenting relevant information regarding their interests, involvement, and impact on project success.

In the context of various embodiments “risk breakdown structure” is a hierarchically organized depiction of the identified project risks arranged by risk category and subcategory that identifies the various areas and causes of potential risks. The risk breakdown structure is often tailored to specific project types. In the context of various embodiments the term “risk breakdown structure” has also associated the meaning of a tool that assists the project manager and the risk manager to better understand recurring risks, and concentrations of risk which would lead to issues that affect the status of the project. Similar with the Work Breakdown Structure, the risk breakdown structure provides a means for the project manager and risk manager to provide a means of structuring the risks being addressed and/or tracked. Therefore, the risk breakdown structure is a hierarchically organized depiction of the identified project risks arranged by risk category.

In the context of various embodiments the term “quantitative risk analysis” is associated the meaning of systematic empirical investigation of quantitative properties, the phenomena and the relationships of risk. The objective of quantitative risk analysis is to develop and employ mathematical models, theories and/or hypotheses pertaining to phenomena. The process of measurement is central to quantitative research because it provides the fundamental connection between empirical observation and mathematical expression of quantitative relationships. In the context of various embodiments the term “quantitative delay analysis” is associated the meaning of “quantitative risk analysis” for delays.

In the context various embodiments the term “event risk analysis” is associated the meaning of a technique employed to identify and assess factors that may jeopardize the success of a project or achieving a goal. This technique also helps to define preventive measures to reduce the probability of these factors from occurring and identify countermeasures to successfully deal with these constraints when they develop to avert possible negative effects on the competitiveness of the company.

In the context of various embodiments the term “risk awareness check” is associated the meaning of charting the quantitative risk (which is the product of risk impact and risk probability) vs. the subjective feeling of the project team regarding the respective risk. The subjective feeling is a ranking from zero for no-risk, 1 a minor risk up to 5—highest impact risk.

In the context of various embodiments the term “schedule sensitivity index” identifies and ranks the tasks most likely to influence the project duration or finish. Schedule Sensitivity Index is expressed as a percentage using the following calculation: SSI=(Criticality Index×Task Standard Deviation)/Project Standard Deviation.

In the context of various embodiments the term “Duration sensitivity” is associated the meaning of the measure of the correlation between the duration of a task and the duration of the project. The task with the highest duration sensitivity is the task that is most likely to increase the project duration. Sensitivity values ranges from −100% to +100%. (Usually negative values can be ignored as only in exceptional circumstances can increasing the duration of a task reduces the duration of the project.)

In the context of various embodiments the term “Criticality index” allows to identify tasks that are likely to cause delays to the project. By monitoring tasks with a high criticality index a project is less likely to be late. Duration Cruciality is calculated from the Duration Sensitivity and the Criticality index (Cruciality=Duration Sensitivity×Criticality index). Duration Cruciality measures of how crucial the task duration is to the project duration. Tasks with a high cruciality are likely to effect the plan duration and therefore finish date.

In the context of various embodiments, by risk management plan is understood the document describing how project risk management will be structured and performed on the project. It is contained in or is a subsidiary plan of the project management plan. Information in the risk management plan varies by application area and project size. The risk management plan is different from the risk register that contains the list of project risks, the results of risk analysis, and the risk responses.

In the context of various embodiments, by “Risk Mitigation” or simply “Mitigation” is understood the response planning technique associated with threats that seeks to reduce the probability of occurrence or impact of a risk to below an acceptable threshold.

In the context of various embodiments, by “Risk Avoidance” or simply “Avoidance” is understood the risk response planning technique for a threat that creates changes to the project management plan that are meant to either eliminate the risk or to protect the project objectives from its impact.

In the context of various embodiments, by “Risk Acceptance” is understood the risk response planning technique that indicates that the project team has decided not to change the project management plan to deal with a risk, or is unable to identify any other suitable response strategy.

In the context of various embodiments, by “Risk Transference” or “Risk Transfer” is understood the risk response planning technique that shifts the impact of a threat to a third party, together with ownership of the response.

In the context of various embodiments the term “Risk Category” is a group of potential causes of risk. Risk causes may be grouped into categories such as technical, external, organizational, environmental, or project management. A category may include subcategories such as technical maturity, weather, or aggressive estimating.

The method of delay estimation according to various embodiments proposes the use of an independent moderator in a risk assessment workshop. The moderator may discuss the project in a structured manner following the risk breakdown structure that is derived from the work breakdown structure.

Embodiments of a method and project management tool for delay estimation and mitigation are described herein. In the following description, numerous specific details are provided for understanding the embodiments. One skilled in the relevant art will recognize, however, that the various embodiments can be practiced without one or more of the specific details, or with other steps, methods, systems, components, materials, etc. In other instances, well-known structures, materials, system components, or steps of methods are not shown, or if shown are not described in detail, to avoid obscuring aspects of the various embodiments.

Reference throughout this specification to “one embodiment” or “an embodiment” means that a particular feature, structure, step, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, steps, or characteristics may be combined in any suitable manner in one or more embodiments.

Various operations will be described as multiple discrete are steps performed in turn in a manner that is most helpful in understanding the various embodiments. However, the order of description should not be construed as to imply that these operations are necessarily order dependent, in particular, the order the steps are presented. Any necessary ordering is alternatively expressly mentioned or will be understood by those skilled in the art.

Economists distinguish between cardinal utility and ordinal utility the last representing a rank-comparison of options, contacts, projects, execution quality, etc. For a customer that has already made a decision that a certain company is executing a project, a cardinal utility function over time is more appropriate for characterizing the project, while the ordinal utility is capable of only capturing ranking and not strength of preferences. When a cardinal utility is used, the magnitude of utility differences is treated as an ethical or behavioral significant quantity. This is a function that has a set of inputs X and yields values in real space R. The theory is around the cardinal utility, meaning that a number is assigned to the utility. Should X be the specified set of requests agreed under the contract and desired by the customer, the customer specific utility function u:X→ [symbol] may estimate the achievements. To the customer specific function, the execution costs may be calculated via e:X→ [symbol] . The overall cardinal utility function collects the customer utility and execution/investment utility functions. When the cardinal utility is used, the magnitude of utility differences reflects the rank-comparison when treated as an ethically or behaviorally significant quantity.

In the context of various embodiments, by cardinal utility is meant the probability of achieving the target project multiplied with its value, minus the costs involved in execution. In the case of a hard deadline project that is completed after the deadline, the project is deemed un-useful and costly. In addition to the loss of execution costs, loss of materials, loss of credibility for execution capability, the customer losses any gains that he would have had if commissioning with the other company.

In the context of various embodiments, by risk management is understood the identification, assessment and prioritization of risks followed by coordinated and economical application of resources to minimize, monitor, and control the probability and/or impact of unfortunate events. Most risk management methodologies comprise at least five elements: identify, characterize, and assess threats, assess the vulnerability of critical assets to specific threats, determine the risk, or unexpected consequences of specific types of attacks on specific assets, identify ways to reduce those risks, and prioritize risk reduction measures based on a strategy.

At least four sources of variability impact risk management: the event-risks which interfere with the project, the intrinsic variability of the accounted activities in terms of costs/duration, the correlations on events & variability, and the environmental changes during the project.

By event risks that interfere with the project are understood the risks due to unforeseen events associated with an activity of a project, company or programme. Event risks may affect one or several activities. Event risks are characterized by the delay impact and the probability.

By intrinsic variability of the activities in terms of costs/duration is understood that achieving the result desired by an activity the costs/durations may vary. The cause of the variability is solely based on inside reasons, without a risk occur. To better understand, activity duration is an approximation, which is incomplete or uncertain. Based on statistics, in order to arrive at a desired estimator for estimating a single or multiple parameters, it is first necessary to determine a model for the system. This model comprises the process being modeled and points of uncertainty and noise. The model describes a scenario in which the parameters apply. The model may comprise errors as well as optimal estimators. When we discuss an intrinsic variability of the activities, we specifically point to errors as well as optimal estimators of activity duration.

By correlations on events & variability in various embodiments it is understood that when two risks are affecting the same activity of a project, and each of the risks is defined by their probability and impact, if the two events are independent the probability that both will occur in the same time is the product of probabilities. The impact of a new event is usually several of orders of magnitude larger than the impact of each of the older events. This may make the correlation of events catastrophic. The same logic can be extended to risk-events combined with the variability of events.

The projects that require the specific attention of risk management span over several years. The economical conditions over this wide extent of time may dramatically change the position of the project in the environment, may change the customer and its ability to pay. This is what is understood in the various embodiments by environmental changes during the project.

The risk analysis methodology according to various embodiments may comprise, in general terms, at least a risk identification phase, an evaluation phase and a mitigation phase. More precisely, the risk identification phase may comprise at least setting up the risk breakdown structure, and a quantitative evaluation around the topics of the risk breakdown structure. The evaluation phase may comprise the identification and evaluation of risk scenarios, the set up of risk portfolio, and a qualitative and quantitative evaluation of risk awareness. The mitigation phase may comprise the identification and evaluation of mitigations, the identification and evaluation of uncertainties, and results and recommendations.

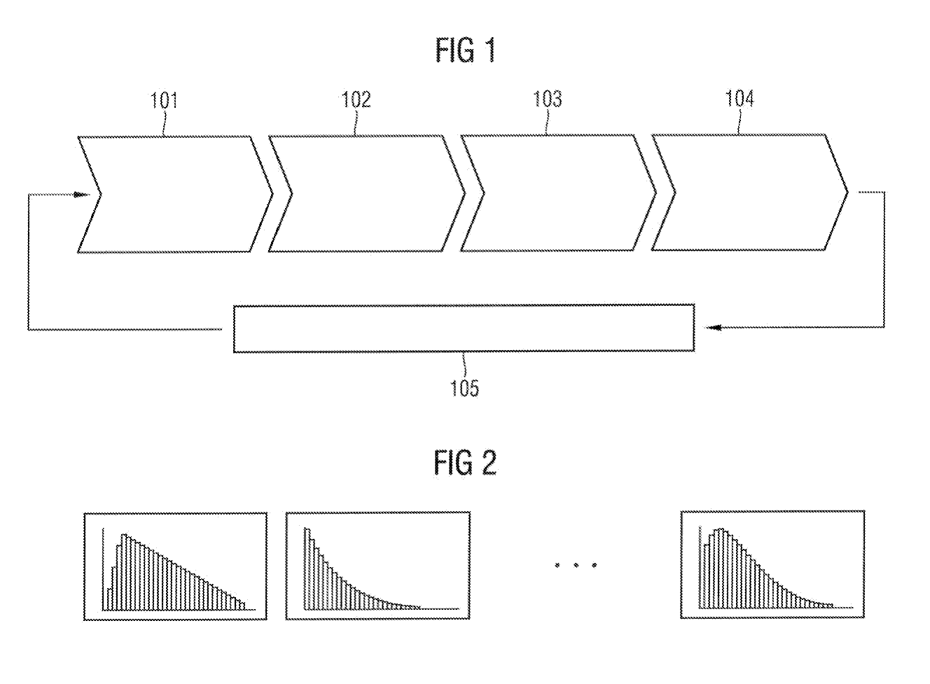

As illustrated in slightly more detail in FIG. 1, the method of delay estimation according to various embodiments may perform in a step 101 an identification of events that alter each start or end of activities, and via, for example a graphics tool, represents and evaluates the uncertainty distribution for the project in step 102. In a subsequent step 103 the methodology estimates various mitigation modalities available. Once said mitigation modalities are clarified and implemented, residual delays may still be present, residual delays that may as well be estimated via the graphics tool, is a subsequent step 104. The monitoring and control of implementation is a step 105 that may be optionally implemented.

The structured moderated discussions held at the same time the project to be reviewed, and among the first steps that are reviewed is the variability of the activities. The variability of activities is represented via Gantt diagrams, which represent the most likely duration for activities. In addition to a “most-likely” value, each activity has an intrinsic variability. For example, design activities may depend on finding earlier-or-not solutions, and these activities may have deviations. The activities span between a minimum expected duration and a maximum expected duration.

Referring now to FIG. 2, said figure is a representation of four histograms representing distributions of the end-of-the-activity curves. The figure shows several examples of histograms for probabilistic end of an activity (or a required milestone).

As known in the art, Gantt has provided a method for visualizing activities, which is employed in the field of project management. The activities are represented in horizontal bars in a calendar manner and connected based on the logical sequence order if one activity depends on the completion of the previous one. In case that the project comprises an event-risk affecting the duration of the project, for example having an occurrence probability of 20%, the original activity may be represented as split in two branches, one labeled no risk and the other risk occurred. The branch labeled no risk has a probability of 80% of existing while the branch risk occurred has a probability of existing of 20%.

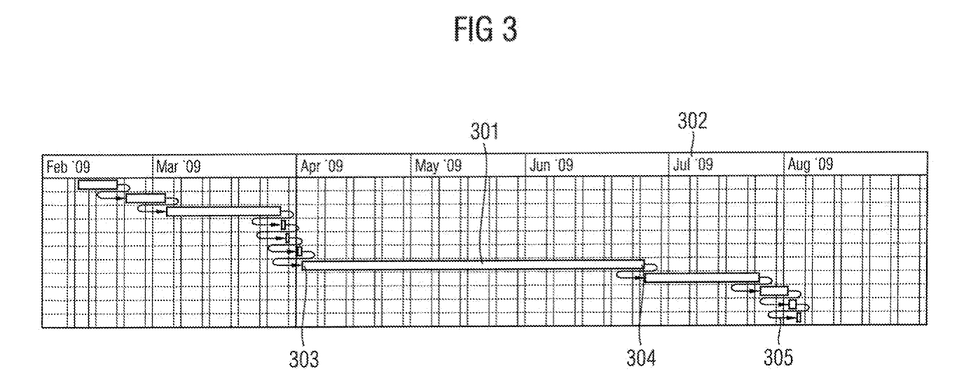

A representation of a Gantt schematics is made in FIG. 3, for an exemplary project.

The Gantt chart represented in FIG. 3 is a bar chart illustrating an exemplary project schedule. A plurality of elements, that may be summary element 301 or terminal elements 305 are illustrated in a chart that comprises the dates 302 within a completion time range for the project. The Gantt chart illustrate the start 303 and finish 304 date of the terminal elements and summary elements of a project. Terminal elements and summary elements comprise the work breakdown structure of the project. The Gantt chart also shows the dependency (i.e. precedence network) relationships between activities. Each terminal element and summary element of the chart has an activity ID, not specifically represented in FIG. 3.

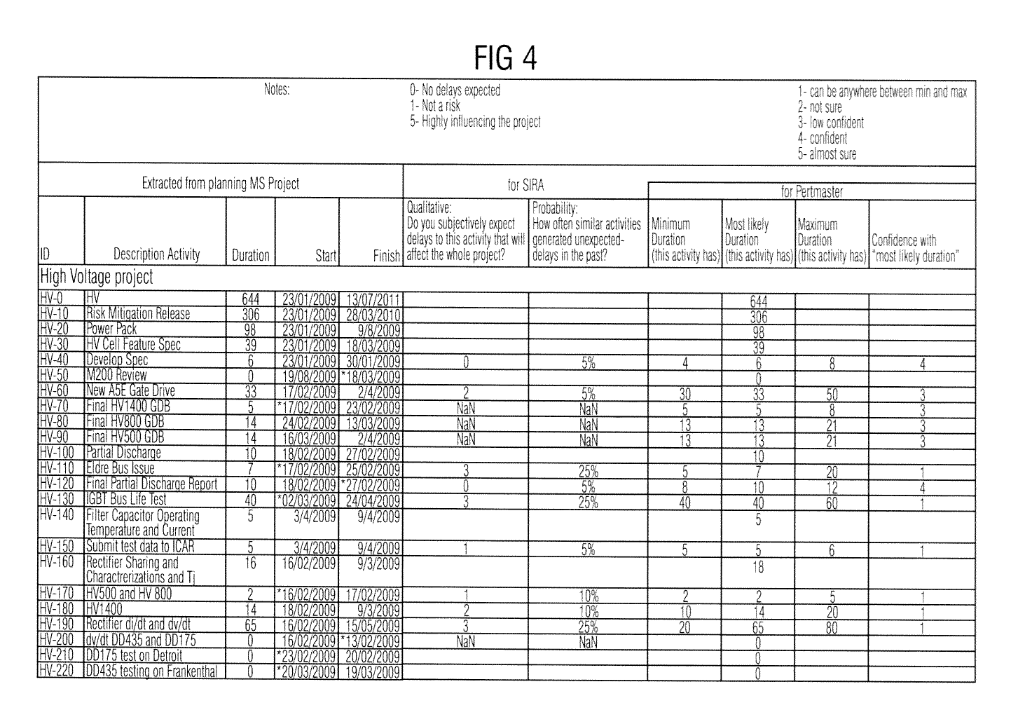

To evaluate the variability of activities, the table illustrated in FIG. 4 is employed to acquire the variability of activities. The activities follow the risk break structure, and are listed in the same order as in the work breakdown structure or Gantt diagrams. Specifically, for the exemplary project in connection with each activity, the moderator acquires as illustrated in FIG. 4 the following fields: ID, which represents an activity ID the same as previously described and employed in the Gantt diagram or listing of the project, a short description of the activity, the duration in days of the activity, and the start and finish date as acquired from the project. These fields may be prepared ahead prior to the meeting, during the preparation stage. Following the moderator acquires from the workshop participants a measure about the likelihood of the activity to hinder the project, how often this activity has delays, a minimum, a maximum and a most likely value for the delay regarding each activity, and the confidence degree regarding each most likely value. When evaluating the intrinsic variability of activities, the moderator aims to acquire absolute values for the durations such as minimum, maximum and most likely value for the delay. The end of the activity of multiple similar activities may generate various distributions, as illustrated in FIG. 2. The moderator acquires empirically the distribution of the end of the activity based on the experience of the specialists or as it was in previous similar projects: uniform distribution which has an equal probability between minimum and maximum and is the most flat distribution, triangle distribution, which is gaining early increases and decreases to a maximum likelihood duration, beta distribution and modified beta distribution with a more sharp shape around maximum likelihood duration.

Models in FIG. 2 (that may be one of: uniform distribution, triangle distribution, beta distribution, and modified beta distribution) aim to approximate the span of the activity. Besides model itself, one needs to consider the applicability of the model (model error) and the cost to optimize for each activity the fit.

The moderator may derive for each activity the minimum expected duration, the maximum expected duration. The most likely duration can be extracted from the existing planning or from Gantt diagrams updated at the time of moderation and from a shape parameter.

The shape parameter is a value from one to five that may be described as one being the most flat distribution of end of activity and five the most sharp distribution around the most likely duration value (see FIG. 2).

The moderation may follow two approaches: one option is to fill each activity with answers one by one. This is an activity focused approach that is time-consuming, while being less accurate with respect with quantity evaluation. The second approach is to go faster over the qualitative evaluation of each activity and to reconvene later to compete details for each activity as “days impact”, probable minimum and maximum duration, confidence, what most likely duration. The second approach may save time and obtain comparable values with regards to quantitative evaluation.

Following the intrinsic variability of the activities, the moderator may further focus on event risks. The advantage of doing it in this order is that the activities may be reviewed during the intrinsic variability evaluation. There are two parameters that are required for event risks: the first is the impact in days, weeks or months with respect to the current activity and the second is the probability of occurrence.

In contrast with the risk evaluation methods that focus on cost evaluation, the various embodiments will calculate LDs or CAPs for the entire project at once. Some event risks are probabilistic part on the critical path dramatically influencing the end to date of the project, while other events affect only local some activities.

Probability of event risks is roughly estimated from previous projects or situations. In a simple approach, the moderator may ask how often this event occurred in the past situations or how often this event may occur in the current environment, allowing therefore, the specialists to provide a probability for the current project. When the above inquiries are completed, the moderator may follow with extracting mitigations and approaches that may help avoiding the presented delay risk.

It is essential to acquire the activities that are affected by the event risks. The moderator shall avoid vague collective activities and extract the exact list of activities affected by the risk. The moderator may ask how much in addition the risk affects the respective activity or percentage of the respective activity. The values should be larger than hundred percent if risks are present. Other options may include additional resources, additional plain days.

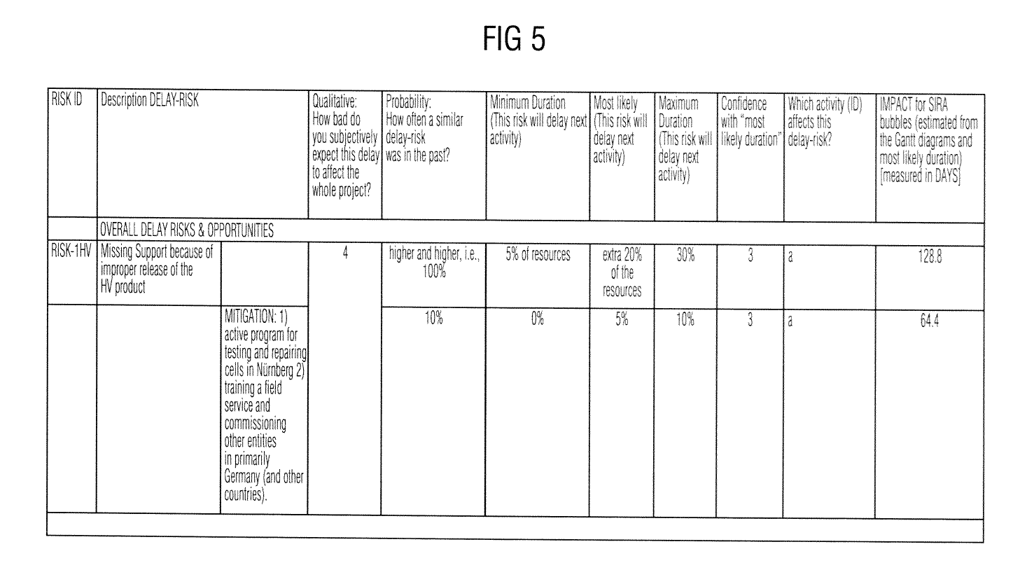

FIG. 5 illustrates an example table of the event risks as acquired by the moderator. The fields of the table are risk ID carried in the Gantt diagrams. In case of extensive roadmaps short but relevant risk IDs should be used so the customer will not confuse a risk with any real activity. Similar to the procedure employed when estimating the variability of the activities of the moderator aims to acquire information about how likely is the risk to hinder project, how often an activity had delays, what the minimum and maximum and most likely delays are in regards with the activity, what is the confidence with the most likely value. For event risks, the moderator is recommended to acquire relative values for the minimum and maximum and most likely delay representing a percentage of the respective activity. Later, based on the criticality of the path, the relative values are transformed in the same units as duration, with a short description regarding how the transformation was made. The second raw, there are the values of successful mitigation in some cases the risk can be reduced only partially.

Similar with intrinsic variability, the moderator may ask for event risks the minimum expected duration the risk may affect a respective activity, the maximum expected impact, and a most likely impact of the event risk. Also, the moderator shall acquire the confidence with most likely duration as the ranking from one to five, having the same meaning as previously discussed regarding confidence at the activity intrinsic variability.

Based on past experience in various projects, it has been observed that the specialists of diverse fields that participate together in a moderation workshop. Easily agree regarding the probability and impact values. Specialists have good empirical knowledge about the occurrence and about the impact of certain risks. They agree easily on technical areas, as well as on mitigation measures that may stop avoid combat the undesired event.

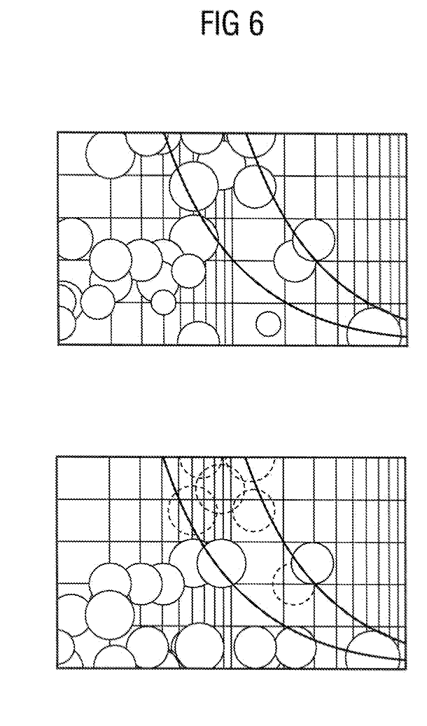

FIG. 6 represents an example of event risk portfolio before and after successful mitigation. The figure represents the probability of occurrence of event risks versus the delay risks, measured in days. Details regarding how to delay may be calculated will be further described in the present document.

A calculation tool is used to synthesize the overall project plan (WBS) with risk events, uncertainty and intrinsic variability. The intrinsic variability is modeled via a calculation tool.

For each event risk, at each activity a Gantt connection split branch is created: one in the case that the event does not occur (this being the default concentration previous to the risk analysis) and one branch for the case the previous estimated risk does occur. This split is modeled, respectively, via the probabilities (1−p) and p, where p is the estimated risk for the event risk.

On the path of non-risk, the activities own the intrinsic variability only. On the event-risk branch the activities are a compound of both intrinsic variability and event risk. The minimum activity duration will be the minimum intrinsic value extended with the event-delay risk. Also, as result-distribution we propose the worse (most flatten) of the two distributions. The estimations upper described are raw multiplied observations.

Alternatively, beta distribution estimations may be constructed from observations. The effects of the event risks on the activity would be the probabilistic distance measure of the two beta distributions. Contrasting, in most practical situations the amount of data is too small so there is no benefit observed from increasing the model's complexity. Certain situations benefit from the estimation for beta distribution and skewness modeling. In Bayesian statistics beta distribution can be seen as the posterior distribution of the parameter p of a binomial distribution after observing α−1 independent events with probability p and β−1 events with probability 1−p, if the prior distribution of p was uniform. By beta distribution is understood a family of continuous probability distributions defined on the interval 0 to 1 parameterized by two positive shape parameters, typically upper denoted by α and β. It is the special case of a Dirichlet distribution with only two parameters.

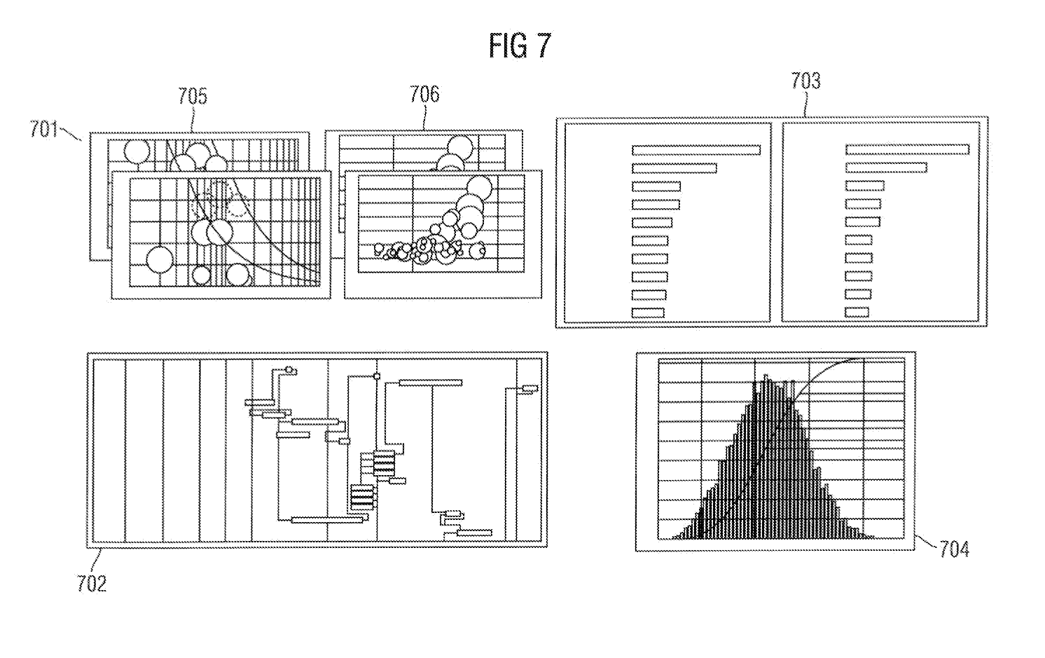

Four types of results are provided, as illustrated in FIG. 7. Said figure represents in a first quadrant 701 the risk and opportunity identification and risk awareness curves, in a second quadrant 702 an assessment of variability in ach activity, in a third quadrant 703 a representation of charts that show how the activities are managed, in terms of cruciality, sensitivity and criticality, and in a fourth quadrant, a curve illustrating a correlated and probabilistic end-date for projects.

First quadrant 701 presents the event-risks depicted on the left side in the graph 705 where on the x-axis is represented the impact of a risk, measured in days at the end of the project. Calculations are based on assessing the probability of activities and the probability that risk will affect the critical-path on a random iteration of 10,000 times estimating a Markov model. On the y-axis is represented the probability the risk to occur. The thumb rule is the past occurrence in similar projects or a prediction of the specialists. Once represented in this x-y coordinates, the risks are worse when own a high probability and a high impact. The two iso-lines present the category of the risk and are based on the project volume.

In the representation 706 the circles represent the risk awareness. At the moderation time, the team members are inquired by the feeling of the risk (one at the time). The subjective value of the risk is represented on the y-axis and the quantitative risk obtained from the product of risk and its probability is on the x-axis. If the team has a good understanding of the risk, the subjective ranking would be proportional with the calculated quantitative risk; therefore the distribution would be on the first diagonal.

In the second quadrant 702 is represented one of the outcomes after evaluating the effect of event-risks and the variability of activities. In a Gantt chart, variability is represented with a tailing effect at the end of the activity. As discussed in the present document in connection with FIG. 4, around the most-likely (ML) term 5 levels of confidence are defined with this ML estimation from 1 to 5. Where 1 is a equal distributed probability and 5 is the most confident on ML term modified beta distributed with more sharp shape around maximum likelihood duration. Some activity may not require or simply is not defined its variability.

Apart, event risks are introduced either via an additional activity, or a split in Gantt diagrams. The choice depends if only one activity is affected or multiple activities (sometimes with the change of the entire branch). After split(s) branches should have the sum of the probability(-ies) equal 100%.

In the third quadrant 703 are represented ranked in decreasing order the cruciality, sensitivity and criticality. These results are standard for risk analysis in project management and calculated as follows:

Criticality is the percentage of Monte-Carlo simulation iterations in which an activity or risk event lies on the schedule critical path. It is therefore a measure of the probability that the activity or the event-risk has a direct effect on the schedule outcome. This criticality value is used to estimate the proportion (initial delay*criticality) for the risk-impact (x-axis) in the representation from top-left-left figure. In the case of event-risks criticality should be smaller than the probability of occurrence (as part of this probability).

Sensitivity or Schedule Sensitivity Index is the ratio between the product of criticality and standard deviation for duration of activity vs. the standard deviation of overall schedule duration. As a measure of uncertainty, variance can be interpreted as being a reflection of a possible opportunity to improve the schedule performance. The standard deviation of overall schedule is higher than the local activity standard deviation ad used as normalization.

Cruciality is the correlation between a task's duration and the overall project end date multiplied by criticality. Cruciality measures how crucial the task duration is to the project duration. Tasks with a high cruciality are likely to effect the plan duration and therefore finish date. NB. Some low values are due to random correlation between the task and the project duration.

The fourth quadrant 704 represents the probabilistic end of the project (or a required milestone). The histogram presents the 10,000 Monte-Carlo iterations between an optimistic end of project and a pessimistic project end. The curve over the histogram is the cumulative end-date of project; it helps to estimate a date when the project may end with e.g., 80% probability.

As discussed above, for each event risk is summarized the impact at the end of the project by simply creating the probability of the branches 0 to 100% and running a Markov simulation that randomly assesses the critical paths with their respective probabilities. Said value is used in the representations of FIG. 7.

Therefore, to summarize, a method according to various embodiments may comprise at least dividing a work breakdown structure of a project plan in a plurality of elements, identifying a plurality of risks and uncertainties in connection with said plurality of elements comprised in the work breakdown structure, estimating a plurality of best duration uncertainty distributions for each element of said plurality of elements, synthesizing, using the plurality of best duration uncertainty distributions, a work breakdown structure of a project plan with uncertainties, and creating an estimate of delays for said project plan.

The method of delay estimation according to various embodiments further may comprise the step of defining a set of goals for a delay analysis derived on the stakeholder analysis on project goals. This may be a narrative description of the project scope, project assumptions, and project constraints that provides a documented basis for developing a common understanding of project scope among the stakeholders.

The method of delay estimation according to various embodiments may further comprise setting up a project specific risk breakdown structure based on the work breakdown structure of a project plan.

The method of delay estimation according to various embodiments may further comprise gaining an understanding regarding the delay risks based on risk events in said project plan and variability from said planed events.

The method of delay estimation according to various embodiments may further comprise making a quantitative evaluation of the plurality of uncertainties.

The method of delay estimation according to various embodiments may further comprise making a intrinsic delay variability analysis based at least on one of a probability, a duration, and an uncertainty distribution.

The method of delay estimation according to various embodiments may further comprise performing an event risk analysis.

The method of delay estimation according to various embodiments may further comprise performing analysis of event-risk correlation: event-risk with other event-risks, but also event risks and intrinsic variability.

The method of delay estimation according to various embodiments may further comprise performing a risk awareness check via performing a qualitative and quantitative risks check.

The method of delay estimation according to various embodiments may further comprise visualizing a probability over impact ratio for the risk portfolio.

The method of delay estimation according to various embodiments may further comprise mitigating risk based on the estimate of delays for the project plan.

The method of delay estimation according to various embodiments may further comprise estimating an end-of-project and a duration distribution for the project plan.

The method of delay estimation according to various embodiments may further comprise evaluating of schedule sensitivity index (SSI).

The method of delay estimation according to various embodiments may further comprise performing an analysis of a critical path and prioritization of risks.

The method of delay estimation according to various embodiments may further comprise planning measures for risk mitigation.

The method of delay estimation according to various embodiments may further comprise calculating and illustrating activity durations and event-risk impact and probability after a successful risk mitigation of each risk mitigation measure. Same representations based on risk impact [days] vs. probability may be generated.

The method of delay estimation according to various embodiments may further comprise demonstrating an overall achievable risk reduction. This step may imply a Monte Carlo analysis that combines randomly the defined risks based on their probability of occurrence.

The method of delay estimation according to various embodiments may further comprise controlling mitigation measures in accordance to a risk mitigation implementation procedure. The primary objectives of risk monitoring and controlling are to track identified risks, monitor residual risks, identify new risks, ensure that the risk response plans are executed at appropriate time, and evaluate their effectiveness through the project life-cycle.

Therefore to summarize, the method of delay estimation according to various embodiments may comprise at least deriving a work breakdown structure of a project plan from a plurality of elements, identifying a plurality of risks and uncertainties in connection with said plurality of elements comprised in the work breakdown structure, estimating a plurality of best duration uncertainty distributions for each element of said plurality of elements, synthesizing, using the plurality of best duration uncertainty distributions, of a work breakdown structure of a project plan with uncertainties, and creating an estimating delays for said project plan.

The various embodiments also concern in one of its embodiments a project management tool. The project management tool may be either an automated or a manual tool that comprises at least a delay estimation module. The delay estimation module approximates delays by employing the at least the method according to various embodiments by dividing a work breakdown structure of a project plan in a plurality of elements, identifying a plurality of risks and uncertainties in connection with the plurality of elements comprised in the work breakdown structure, estimating a plurality of best duration uncertainty distributions for each element of said plurality of elements, synthesizing, using the plurality of best duration uncertainty distributions, a work breakdown structure of a project plan with uncertainties, and creating an estimate of delays for said project plan.

The project management tool may be employed manually or automatically by a moderator, that as well may be embodied by a person or an automated tool.

The project management tool according to various embodiments may comprise at least a delay estimation module, the delay estimation module estimating delays by dividing a work breakdown structure of a project plan in a plurality of elements, identifying a plurality of risks and uncertainties in connection with said plurality of elements comprised in the work breakdown structure, estimating a plurality of best duration uncertainty distributions for each element of said plurality of elements, synthesizing, using the plurality of best duration uncertainty distributions, a work breakdown structure of a project plan with uncertainties, and creating an estimate of delays for said project plan.

According to other embodiments, a system using the method of delay estimation for project delay risk mitigation, may comprise software means residing in a delay estimation means.

The above description of illustrated embodiments, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method of delay estimation, comprising:
deriving a work breakdown structure of a project plan from a plurality of elements;
identifying a plurality of risks and uncertainties in connection with said plurality of elements comprised in the work breakdown structure;
estimating a plurality of best duration uncertainty distributions for each element of said plurality of elements;
synthesizing, using the plurality of best duration uncertainty distributions, of a work breakdown structure of a project plan with uncertainties, and
creating an estimating delays for said project plan.

2. The method of delay estimation according to claim 1, further comprising: defining a set of goals for a delay analysis based on a stakeholder analysis and on project goals.

3. The method of delay estimation according to claim 1, further comprising: setting up a project specific risk breakdown structure based on the work breakdown structure of a project plan.

4. The method of delay estimation according to claim 1, further comprising: gaining an understanding regarding the delay risks based on planed events in said project plan and variability from said planed events.

5. The method of delay estimation according to claim 1, further comprising: making a quantitative evaluation of the plurality of uncertainties.

6. The method of delay estimation according to claim 1, further comprising: making a quantitative delay variability analysis based at least on one of a probability, a duration, and an uncertainty distribution.

7. The method of delay estimation according to claim 1, further comprising: performing an event risk-analysis.

8. The method of delay estimation according to claim 1, further comprising: performing an event correlation analysis.

9. The method of delay estimation according to claim 1, further comprising: deriving a risk awareness check via performing a qualitative and quantitative risks check.

10. The method of delay estimation according to claim 1, further comprising: visualizing the probability over impact ratio for the risk portfolio.

11. The method of delay estimation according to claim 1, further comprising: mitigating risk based on said estimate of delays for said project plan.

12. The method of delay estimation according to claim 11, comprising estimating the end-of-project as well as important milestones via a duration distribution and a cumulative distribution for the project plan.

13. The method of delay estimation according to claim 11, further comprising: evaluating of a schedule sensitivity index (SSI).

14. The method of delay estimation according to claim 11, further comprising: performing an analysis of a critical path and prioritization of risks.

15. The method of delay estimation according to claim 1, further comprising: planning measures for risk mitigation.

16. The method of delay estimation according to claim 1, further comprising: calculating and illustrating achievable risk mitigation for each risk mitigation measure.

17. The method of delay estimation according to claim 1, further comprising: demonstrating an overall achievable risk reduction.

18. The method of delay estimation according to claim 1, further comprising: controlling mitigation measures in accordance to a risk mitigation implementation procedure.

19. A project management tool, comprising
a delay estimation module, the delay estimation module being operable to estimate delays by:
dividing a work breakdown structure of a project plan in a plurality of elements;
identifying a plurality of risks and uncertainties in connection with said plurality of elements comprised in the work breakdown structure;
estimating a plurality of best duration uncertainty distributions for each element of said plurality of elements;
synthesizing, using the plurality of best duration uncertainty distributions, a work breakdown structure of a project plan with uncertainties, and
creating an estimate of delays for said project plan.
